(19) United States
(12) Patent Application Publication
(10) Pub. No.: US 2016/0305612 A1
(43) Pub. Date: Oct. 20, 2016

(54) PERFLUORO PHOSPHATE-TYPE GAS PIPELINE DRAG-REDUCING AGENT AND METHOD OF PREPARING SAME

(71) Applicant: PETROCHINA COMPANY LIMITED, Beijing (CN)

(72) Inventors: Zhiheng ZHANG, Beijing (CN); Guoping LI, Beijing (CN); Guangwen LIU, Beijing (CN); Muyang AI, Beijing (CN); Haifeng GUO, Beijing (CN); Weichun CHANG, Beijing (CN); Xiaodong DAI, Beijing (CN); Chunman LI, Beijing (CN); Fajie YANG, Beijing (CN)

(21) Appl. No.: 15/035,213

(22) PCT Filed: Nov. 7, 2014
(86) PCT No.: PCT/CN2014/090594

§ 371 Date: Jul. 1, 2016

(30) Foreign Application Priority Data
Nov. 8, 2013 (CN) 201310551926.5

(51) Int. Cl. F17D 1/02; C10L 3/06; C09D 7/12

(52) U.S. Cl. CPC F17D 1/02; C09D 7/1233; C09D 7/1216; C10L 3/06

(57) ABSTRACT

The present invention provides a perfluorophosphate-based drag-reducing agent for gas pipelines. Raw materials for the perfluorophosphate-based drag-reducing agent for gas pipelines consist of fatty acid(s), pyridine(s), fluorophosphates(s) and haloalkane(s) in a mass ratio of 2:1:1:1 to 2:3:1:2. A method for preparing the perfluorophosphate-based drag-reducing agent for gas pipelines is also provided. The perfluorophosphate-based drag-reducing agent for gas pipelines is non-toxic and environmentally friendly, has a high drag reduction percentage, a long-lasting effect, good stability and solubility, does not affect the inner surface and coatings of natural gas pipelines or gas quality, and is suitable for on-line atomization and injection.

### TECHNICAL FIELD

The present invention relates to a drag-reducing agent for gas pipelines and the method for preparing the same, and in particular to a perfluorophosphate-based gas pipeline drag-reducing agent for drag reduction in long-distance natural gas pipelines and its preparation method. The present invention pertains to the field of organic macromolecular compounds and preparation methods.

### BACKGROUND ART

Natural gas is the cleanest energy source that causes minimum contamination, and consequently its share in the primary energy sources being used has been rapidly increasing, resulting in rapid development in the natural gas pipeline network. Currently, natural gas is transported mainly through pipelines. Modern gas pipelines have been developed for nearly 120 years. When gas flows through pipelines, roughness causes friction, which creates a vortex flow of gas, leading to energy loss and in turn pressure drop along the pipelines. For pipeline transport of natural gas in a turbulent state, roughness of the pipe wall dictates the friction coefficient, and an increase in pipeline throughput requires reduction in roughness of the pipe wall. In various domestic and foreign places, demands for natural gas vary markedly between different seasons, and such variation requires the gas pipeline network to have certain adjustability, especially the ability to increase the pipeline throughput in a short time while ensuring safety.

Therefore, how to develop a drag-reducing agent for natural gas similar to those for oil, to make a breakthrough in the advancement of drag-reducing techniques for natural gas pipelines, is a problem that urgently needs to be solved in the art.

Recently, tremendous advances have been made in studies on drag reduction in pipeline transport of natural gas. In current research results, drag-reducing methods can be generally categorized into drag-reducing techniques based on coatings lining natural gas pipelines, and drag-reducing techniques using a drag-reducing agent.

It is well recognized that drag-reducing agents for natural gas, like those for crude oil, may significantly increase the pipeline throughput, reduce the power consumption of compressors, lower the installation power of compressors, reduce the number of compressor stations, deliver enormous economic benefits, are much desired in practical production, and have excellent prospects in the market. However, drag-reducing agents for natural gas are different from drag-reducing agents for commercial liquids (such as petroleum). Drag-reducing agents for liquids, such as that used in the Trans-Alaska pipeline of crude oil, is a typical long-chain polymer having a molecular weight of several million Daltons, which is merged into the liquid phase to reduce vortex flow in the liquid. A drag-reducing agent for liquids expands the bottom layer of the laminar flow from the inner surface of the pipe to the central turbulent area, with its effecting area at the interface between the laminar flow and the turbulent flow. In contrast, drag-reducing agents for natural gas cannot have a very high molecular weight, as their ability to be atomized and ability to “fill” the “pits” in the pipe wall should be considered. Furthermore, drag-reducing agents for natural gas do not take effect at the interface between the laminar flow and the turbulent flow, but directly act on the inner surface of the pipe, where the molecules of the drag-reducing agents are firmly bound to the metal surface to form a smooth, flexible surface, so as to ease off the turbulence at the gas-solid interface and reduce friction between the fluid and the pipe wall, i.e., directly lower the roughness of the inner surface of the pipeline, so that the drag can be reduced without altering the properties of the fluid.

Patent documents U.S. Pat. No. 4,958,653 and U.S. Pat. No. 5,020,561 both propose a method for reducing the drag in a gas pipeline with a drag-reducing agent.

### SUMMARY OF INVENTION

In order to address the above problem, the present invention aims to provide a highly effective drag-reducing agent for natural gas transported in long-distance pipelines and its preparation method, wherein the drag-reducing agent is non-toxic and environmentally friendly, has a high drag reduction percentage, a long-lasting effect, good stability and solubility, does not affect the inner surface and coatings of natural gas pipelines or gas quality, and is suitable for online atomization and injection.

In order to accomplish the above objectives, the present invention first provides a perfluorophosphate-based drag-reducing agent for gas pipelines, consisting of fatty acid(s), pyridine(s), fluorophosphates(s) and haloalkane(s) in a mass ratio of 2:1:1:1 to 2:3:1:2.

In the perfluorophosphate-based drag-reducing agent for gas pipelines provided according to the present invention, the fatty acid(s) used is preferably selected from palmitic acid, oleic acid, lauric acid, linoleic acid, stearic acid, linolenic acid, myristic acid, arachidic acid, cerotic acid, or lignoceric acid.

In the perfluorophosphate-based drag-reducing agent for gas pipelines provided according to the present invention, the pyridine(s) used is preferably selected from pyridine, 2-chloro-pyridine, 2-mercapto-pyridine, 2,6-dibromo-pyridine, N-ethylpyridine, 2,3-dichloro-pyridine, 3,5-dibromo-pyridine, N-methylpyridine, 2-vinylpyridine, 2,5-dibromo-pyridine, or 2,6-dichloro-pyridine.

In the perfluorophosphate-based drag-reducing agent for gas pipelines provided according to the present invention, the haloalkane(s) used is preferably selected from chloroethane, chloropentane, chlorohexane, chloroheptane, chlorooctane, chlorododecane, chlorohexadecane, bromoethane, bromobutane, bromopentane, bromohexane, bromoheptane, bromooctane, bromododecane, or bromohexadecane.

In the perfluorophosphate-based drag-reducing agent for gas pipelines provided according to the present invention, the fluorophosphates(s) used is preferably selected from ammonium fluorophosphate, zinc fluorophosphate, aluminum fluorophosphate, lithium fluorophosphate, sodium fluorophosphate, calcium fluorophosphate, or potassium fluorophosphate.

The present invention further provides a method for preparing the perfluorophosphate-based drag-reducing agent for gas pipelines, the method comprising the steps of:

Step 1: adding the fatty acid(s) and pyridine(s) in a ratio to a reaction vessel, and allowing them to undergo reaction in an inert atmosphere at a controlled temperature of 40° C. to 50° C. under stirring;

Step 2: adding the haloalkane(s) in a ratio to the reaction vessel, and allowing it to undergo reaction under reflex in an inert atmosphere at a controlled temperature of 60° C. to 70° C. under stirring, followed by cooling, to obtain a slightly yellow liquid as the upper layer and a white crystal as the lower layer;

Step 3: in an inert atmosphere, decanting the liquid of the upper layer, and crushing the white crystal for suction filtration;

Step 4: placing the white crystal in a thermostatic refiner to carry out hot filtration, and repeating the above operation 2-3 times in an inert atmosphere to obtain a white crystal; in particular, repeating Step 4 two or three times to obtain a white crystal;

Step 5: adding the white crystal and an organic solvent to a reaction vessel, slowly adding the fluorophosphate(s) thereto under stirring in an inert atmosphere, and allowing them to react at a controlled temperature of 20° C. to 40° C.;

Step 6: subjecting the liquid to suction filtration to remove undissolved substances to obtain a crude product, wherein the crude product contains the solvent;

Step 7: evaporating some organic solvent from the crude product with a rotary evaporator, and then placing the product in a vacuum oven to completely remove the organic solvent by evaporation, to obtain the perfluorophosphate-based drag-reducing agent for gas pipelines.

Preferably, the method for preparing the perfluorophosphate-based drag-reducing agent for gas pipelines provided according to the present invention specifically comprises the steps of:

Step 1: adding the fatty acid(s) and pyridine(s) in a mass ratio of 2:1 to 2:3 to a reaction vessel, and stirring them for 4-8 hours and leaving them to stabilize for 2-8 hours in an inert atmosphere at a temperature of 40° C. to 50° C.;

Step 2: adding the haloalkane(s) in a ratio to the reaction vessel; in an inert atmosphere and under stirring, leaving them to stabilize for 2-4 hours at a controlled temperature of 60° C. to 70° C. first, and then slowly raising the reaction temperature to 90° C. to 120° C. followed by refluxing for 48-72 hours; stopping heating to obtain a reaction mixture, and cooling the reaction mixture for 2-4 hours, to obtain a slightly yellow liquid as the upper layer and a white crystal as the lower layer;

Step 3: in an inert atmosphere, decanting the liquid of the upper layer, and crushing the white crystal of the lower layer for suction filtration;

Step 4: placing the white crystal in a thermostatic refiner, adding a solvent thereto, and completely dissolving the white crystal by refluxing for 2-4 hours at a temperature of 80° C. to 120° C.; carrying out hot filtration in the thermostatic refiner to remove undissolved substances; cooling the liquid filtrate to allow crystallization for 2-12 hours; in an inert atmosphere, crushing the crystal for suction filtration; repeating the above operations 2-3 times to obtain a white crystal; in particular, repeating Step 4 two or three times to obtain a white crystal; more preferably, the solvent includes aromatic solvents such as toluene, xylene, nitrobenzene, or phenol, etc.;

Step 5: adding the white crystal and an organic solvent in a mass ratio of 1:2 to 1:5 to a reaction vessel, slowly adding the fluorophosphate(s) in a mass ratio of white crystal to fluorophosphate of 2:1 to 1:2 under stirring in an inert atmosphere, and allowing them to react for 12-24 hours at a reaction temperature maintained at 20° C. to 40° C., to obtain a liquid;

Step 6: subjecting the liquid to suction filtration to remove undissolved substances to obtain a crude product;

Step 7: evaporating some organic solvent from the crude product at 30° C. to 60° C. with a rotary evaporator, and then placing the product in a vacuum oven at a controlled temperature of 30° C. to 60° C. for 1-24 hours to completely remove the organic solvent by evaporation, to obtain the perfluorophosphate-based drag-reducing agent for gas pipelines.

In the method for preparing the perfluorophosphate-based drag-reducing agent for gas pipelines provided according to the present invention, the organic solvent used is preferably a haloalkane organic solvent or an aromatic organic solvent; more preferably, the haloalkane organic solvent includes organic solvents such as chloroform, trichloromethane, dichloromethane, chlorobutane, bromobutane, etc.; and the aromatic organic solvent includes organic solvents such as toluene, xylene, nitrobenzene, or phenol, etc.

The perfluorophosphate-based drag-reducing agent for gas pipelines provided according to the present invention employ special macromolecular compounds or polymers having structural characteristics similar to those of surfactants. The polar ends of the macromolecular compounds or polymers firmly bind to the inner metal surface of the pipe to form a smooth film, and the non-polar ends thereof are located at the gas-solid interface formed between the fluid and the inner surface of the pipe. The special molecular structure of the film is used to absorb the turbulence energy at the interface between the fluid and the inner surface to reduce the energy consumed at the inner surface, and the absorbed turbulence energy then dissipates into the fluid to reduce the turbulence disorder, so that the drag is reduced.

The perfluorophosphate-based drag-reducing agent for gas pipelines and the preparation thereof provided according to the present invention have the following advantages:
after introduced into natural gas pipelines, the drag-reducing agent of the present invention adheres to the inner surface of the pipeline and forms a film, thereby significantly reducing the roughness of the inner surface of the pipelines, where the “pits” in the surface are “filled” and the filling is uniform;
in addition, after the film is formed, the corroded products previously existing on the metal surface disappear, indicating the application value of the drag-reducing agent of the present invention in drag reduction; the film on the surface has good flexibility, indicating that the synthetic pyridine salt-based drag-reducing agent possesses properties required by drag-reducing agents for natural gas, and its film-forming performance and flexibility amply demonstrate its potential application value as a drag-reducing agent for natural gas;
the perfluorophosphate-based drag-reducing agent for gas pipelines according to the present invention shows a remarkable drag-reducing effect in gas pipelines; its raw materials are available from direct sources; and its preparation method has simple operation, mild reaction conditions, and low requirements on instruments, and easily realizes large-scale industrial production.

### DESCRIPTION OF DRAWINGS

FIG. 1 is a SEM image of the original surface of a steel sheet;

FIG. 2 is a SEM image of the surface of the steel sheet coated with the perfluorophosphate-based drag-reducing agent for gas pipelines according to Example 3.

### DETAILED DESCRIPTION OF INVENTION

In order to allow better understanding of the technical features, objectives and beneficial effects of the present invention, detailed description of the technical solutions of the present invention will be provided below, but should not to be construed as limiting the scope of the present invention.

### Example 1

This example provides a perfluorophosphate-based drag-reducing agent for gas pipelines and its preparation method, the method specifically comprising the following steps:
adding 200 g lignoceric acid and 100 g N-methylpyridine to a 500 ml three-neck flask, and stirring them for 8 hours and then leaving them to stabilize for 4 hours in an inert atmosphere at a controlled temperature of 50° C.;
adding 200 g bromobutane to the reaction vessel; in an inert atmosphere and under stirring, leaving them to stabilize for 4 hours at a controlled temperature of 70° C. first, and then slowly raising the reaction temperature to 120° C. followed by refluxing for 72 hours; stopping heating, followed by cooling for 2 hours, to obtain a slightly yellow liquid as the upper layer and a white crystal as the lower layer;
in an inert atmosphere, decanting the liquid of the upper layer, and crushing the white crystal for suction filtration;
placing the white crystal in a thermostatic refiner, adding a solvent thereto, and completely dissolving the white crystal by refluxing for 4 hours at 120° C.; carrying out hot filtration in the thermostatic refiner to remove undissolved substances; cooling the liquid filtrate to allow crystallization for 2 hours to obtain crystal; in an inert atmosphere, crushing the crystal for suction filtration; repeating the above operations 2-3 times to obtain a white crystal;
adding the white crystal and an organic solvent to a reaction vessel, slowly adding 100 g ammonium fluorophosphate under stirring in an inert atmosphere, and allowing them to react for 12 hours at a temperature maintained at 40° C., to obtain a liquid;
subjecting the liquid to suction filtration to remove undissolved substances to obtain a crude product containing the solvent;
evaporating some organic solvent from the crude product at 60° C. with a rotary evaporator, and then placing the product in a vacuum oven at a controlled temperature of 60° C. for 24 hours to completely remove the organic solvent by evaporation, to obtain the perfluorophosphate-based drag-reducing agent for gas pipelines.

### Example 2

This example provides a perfluorophosphate-based drag-reducing agent for gas pipelines and its preparation method, the method specifically comprising the following steps:
adding 100 ml palmitic acid and 100 ml N-ethylpyridine to a 500 ml three-neck flask, and stirring them for 6 hours and then leaving them to stabilize for 4 hours in an inert atmosphere at a controlled temperature of 50° C.;
adding 100 g bromohexane to the reaction vessel; in an inert atmosphere and under stirring, leaving them to stabilize for 4 hours at a controlled temperature of 60° C. first, and then slowly raising the reaction temperature to 110° C. followed by refluxing for 72 hours; stopping heating, followed by cooling for 3 hours, to obtain a slightly yellow liquid as the upper layer and a white crystal as the lower layer;
in an inert atmosphere, decanting the liquid of the upper layer, and crushing the white crystal for suction filtration;
placing the white crystal in a thermostatic refiner, adding a solvent thereto, and completely dissolving the white crystal by refluxing for 4 hours at 110° C.; carrying out hot filtration in the thermostatic refiner to remove undissolved substances; cooling the liquid filtrate to allow crystallization for 8 hours to obtain crystal; in an inert atmosphere, crushing the crystal for suction filtration; repeating the above operations 2-3 times to obtain a white crystal;
adding the white crystal and an organic solvent to a reaction vessel, slowly adding 150 g sodium fluorophosphate under stirring in an inert atmosphere, and allowing them to react for 12 hours at a temperature maintained at 40° C., to obtain a liquid;
subjecting the liquid to suction filtration to remove undissolved substances to obtain a crude product containing the solvent;
evaporating some organic solvent from the crude product at 50° C. with a rotary evaporator, and then placing the product in a vacuum oven at a controlled temperature of 50° C. for 24 hours to completely remove the organic solvent by evaporation, to obtain the perfluorophosphate-based drag-reducing agent for gas pipelines.

### Example 3

This example provides a perfluorophosphate-based drag-reducing agent for gas pipelines and its preparation method, the method specifically comprising the following steps:
adding 100 g lauric acid and 150 g N-methylpyridine to a 500 ml three-neck flask, and stirring them for 4 hours and then leaving them to stabilize for 2 hours in an inert atmosphere at a controlled temperature of 40° C.;
adding 100 g bromobutane to the reaction vessel; in an inert atmosphere and under stirring, leaving them to stabilize for 2 hours at a controlled temperature of 60° C. first, and then slowly raising the reaction temperature to 90° C. followed by refluxing for 48 hours; stopping heating, followed by cooling for 4 hours, to obtain a slightly yellow liquid as the upper layer and a white crystal as the lower layer;
in an inert atmosphere, decanting the liquid of the upper layer, and crushing the white crystal for suction filtration;
placing the white crystal in a thermostatic refiner, adding a solvent thereto, and completely dissolving the white crystal by refluxing for 2 hours at 90° C.; carrying out hot filtration in the thermostatic refiner to remove undissolved substances; cooling the liquid filtrate to allow crystallization for 12 hours; in an inert atmosphere, crushing the crystal for suction filtration; repeating the above operations 2-3 times to obtain a white crystal;
adding the white crystal and an organic solvent to a reaction vessel, slowly adding 100 g ammonium fluorophosphate under stirring in an inert atmosphere, and allowing them to react for 12 hours at a temperature maintained at 20° C., to obtain a liquid;
subjecting the liquid to suction filtration to remove undissolved substances to obtain a crude product containing the solvent;
evaporating some organic solvent from the crude product at 30° C. with a rotary evaporator, and then placing the product in a vacuum oven at a controlled temperature of 30° C. for 12 hours to completely remove the organic solvent by evaporation, to obtain the perfluorophosphate-based drag-reducing agent for gas pipelines.

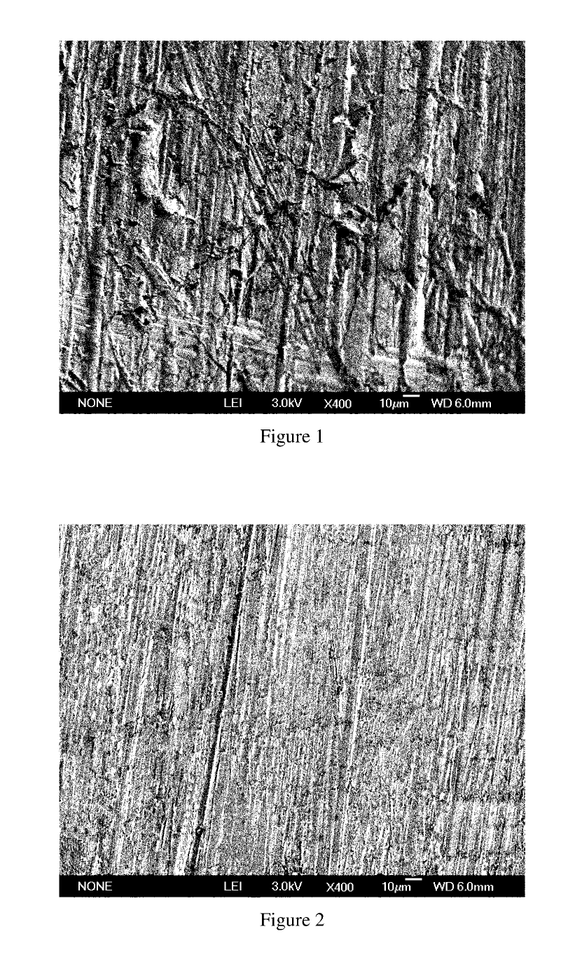

The perfluorophosphate-based drag-reducing agent for gas pipelines obtained according to this example was subjected to a film-forming process and an electronic microscopic analysis by dissolving a certain amount of the product in an appropriate amount of solvent (such as diesel, kerosene, butanol, hexanol, octanol, etc.), immersing a treated (degreased, rust removed, and polished with metallographic sand paper) steel sheet (the SEM image of the original surface of the steel sheet is shown in FIG. 1) in the solvent, taking the sheet out after a certain period of time and drying it, and subjecting it to a microscopic analysis on a JEDL JSM-6700F scanning electronic microscope.

The results show that for the steel sheet surface coated with the perfluorophosphate-based drag-reducing agent for gas pipelines according to this example (as shown in FIG. 2), its roughness has been significantly improved, wherein the “pits” in the surface are “filled” and the filling is uniform. Furthermore, after a film was formed, the perfluorophosphate-based drag-reducing agent for gas pipelines was tested in the in-door evaluation system for natural gas drag-reducing agents (according to the indoor testing method for drag-reducing effects of drag-reducing agents for natural gas, Standard No.: Q/SY GD0221-2012). The results show that the drag reduction percentage is greater than 20%, and this effect stably persists for over 90 days, indicating that the perfluorophosphate-based drag-reducing agent for gas pipelines is valuable in drag reduction applications for gas pipelines.

1. A perfluorophosphate-based drag-reducing agent for gas pipelines, the raw materials for the drag-reducing agent consisting of fatty acid(s), pyridine(s), fluorophosphates(s) and haloalkane(s) in a mass ratio of 2:1:1:1 to 2:3:1:2.

2. The perfluorophosphate-based drag-reducing agent for gas pipelines according to claim 1, wherein the fatty acid(s) is selected from the group consisting of palmitic acid, oleic acid, lauric acid, linoleic acid, stearic acid, linolenic acid, myristic acid, arachidic acid, cerotic acid, and lignoceric acid.

3. The perfluorophosphate-based drag-reducing agent for gas pipelines according to claim 1, wherein the pyridine(s) is selected from the group consisting of pyridine, 2-chloro-pyridine, 2-mercapto-pyridine, 2,6-dibromo-pyridine, N-ethylpyridine, 2,3-dichloro-pyridine, 3,5-dibromo-pyridine, N-methylpyridine, 2-vinylpyridine, 2,5-dibromo-pyridine, and 2,6-dichloro-pyridine.

4. The perfluorophosphate-based drag-reducing agent for gas pipelines according to claim 1, wherein the haloalkane(s) is selected from the group consisting of chloroethane, chloropentane, chlorohexane, chloroheptane, chlorooctane, chlorododecane, chlorohexadecane, bromoethane, bromobutane, bromopentane, bromohexane, bromoheptane, bromooctane, bromododecane, and bromohexadecane.

5. The perfluorophosphate-based drag-reducing agent for gas pipelines according to claim 1, wherein the fluorophosphates(s) is selected from the group consisting of ammonium fluorophosphate, zinc fluorophosphate, aluminum fluorophosphate, lithium fluorophosphate, sodium fluorophosphate, calcium fluorophosphate, and potassium fluorophosphate.

6. A method for preparing the perfluorophosphate-based drag-reducing agent for gas pipelines according to claim 1, the method comprising the steps of:
Step 1: adding the fatty acid(s) and pyridine(s) in a ratio to a reaction vessel, and allowing them to undergo reaction in an inert atmosphere at a controlled temperature of 40° C. to 50° C. under stirring;
Step 2: adding the haloalkane(s) in a ratio to the reaction vessel, and allowing it to undergo reaction under reflex in an inert atmosphere at a controlled temperature of 60° C. to 70° C. under stirring, followed by cooling, to obtain a slightly yellow liquid as the upper layer and a white crystal as the lower layer;
Step 3: in an inert atmosphere, decanting the liquid of the upper layer, and crushing the white crystal for suction filtration;
Step 4: placing the white crystal in a thermostatic refiner to carry out hot filtration, and repeating the above operation 2-3 times in an inert atmosphere to obtain a white crystal;
Step 5: adding the white crystal and an organic solvent in a ratio to a reaction vessel, slowly adding the fluorophosphate(s) thereto under stirring in an inert atmosphere, and allowing them to react at a controlled temperature of 20° C. to 40° C.;
Step 6: subjecting the liquid to suction filtration to remove undissolved substances to obtain a crude product;
Step 7: evaporating some organic solvent from the crude product with a rotary evaporator, and then placing the product in a vacuum oven to completely remove the organic solvent by evaporation, to obtain the perfluorophosphate-based drag-reducing agent for gas pipelines.

7. The method for preparing the perfluorophosphate-based drag-reducing agent for gas pipelines according to claim 6, wherein the method comprises the steps of:
Step 1: adding the fatty acid(s) and pyridine(s) in a mass ratio of 2:1 to 2:3 to a reaction vessel, and stirring them for 4-8 hours and leaving them to stabilize for 2-8 hours in an inert atmosphere at a temperature of 40° C. to 50° C.;
Step 2: adding the haloalkane(s) in a ratio to the reaction vessel; in an inert atmosphere and under stirring, leaving them to stabilize for 2-4 hours at a controlled temperature of 60° C. to 70° C. first, and then slowly raising the reaction temperature to 90° C. to 120° C. followed by refluxing for 48-72 hours; stopping heating to obtain a reaction mixture, and cooling the reaction mixture for 2-4 hours, to obtain a slightly yellow liquid as the upper layer and a white crystal as the lower layer;
Step 3: in an inert atmosphere, decanting the liquid of the upper layer, and crushing the white crystal of the lower layer for suction filtration;
Step 4: placing the white crystal in a thermostatic refiner, adding a solvent thereto, and completely dissolving the white crystal by refluxing for 2-4 hours at a temperature of 80° C. to 120° C. under heating; carrying out hot filtration in the thermostatic refiner to remove undissolved substances; cooling the liquid filtrate to allow crystallization for 2-12 hours; in an inert atmosphere, crushing the crystal for suction filtration; repeating the above operations 2-3 times to obtain a white crystal;
Step 5: adding the white crystal and an organic solvent in a mass ratio of 1:2 to 1:5 to a reaction vessel, slowly adding the fluorophosphate(s) in a mass ratio of white crystal to fluorophosphate of 2:1 to 1:2 under stirring in an inert atmosphere, and allowing them to react for 12-24 hours at a reaction temperature maintained at 20° C. to 40° C., to obtain a liquid;
Step 6: subjecting the liquid to suction filtration to remove undissolved substances to obtain a crude product;
Step 7: evaporating some organic solvent from the crude product at 30° C. to 60° C. with a rotary evaporator, and then placing the product in a vacuum oven at a controlled temperature of 30° C. to 60° C. for 1-24 hours to completely remove the organic solvent by evaporation, to obtain the perfluorophosphate-based drag-reducing agent for gas pipelines.

8. The method for preparing the perfluorophosphate-based drag-reducing agent for gas pipelines according to claim 7, wherein the organic solvent is a haloalkane organic solvent or an aromatic organic solvent.
